(19) United States
(12) Patent Application Publication
(10) Pub. No.: US 2014/0195315 A1
(43) Pub. Date: Jul. 10, 2014

(54) Apparatus for Collecting Objects

(71) Applicants: Marat Gekelman, Brooklyn, NY (US); Alexander Korik, Brooklyn, NY (US)

(72) Inventors: Marat Gekelman, Brooklyn, NY (US); Alexander Korik, Brooklyn, NY (US)

(21) Appl. No.: 13/735,529

(22) Filed: Jan. 7, 2013

(51) Int. Cl. G06Q 30/02

(52) U.S. Cl. CPC G06Q 30/0209
USPC 705/14.11

(57) ABSTRACT

An apparatus for collecting objects has a container for receiving and collecting objects, a unit in the container for determining a weight of an object introduced in the container, and a unit providing compensation to a person who introduced the object into the container, based on the weight of the object determined by the weight determining unit.

### BACKGROUND OF THE INVENTION

The present invention relates to apparatuses for collecting objects, such as for example, clothes and the like.

Apparatuses of the above mentioned type are generally known in the art. A known apparatus of this type has a container with an inlet, through which people can introduce clothes and the like, which later on can be removed from the container and used, for example distributed to needy population. These apparatuses however are not provided with means, which give certain compensation to the people who bring and deposit the objects, such as clothes and the like, into the containers. It is therefore believed to be advisable to further improve the apparatuses of this type, so as to stimulate receiving and collection of more objects into such apparatuses.

### SUMMARY OF THE INVENTION

Accordingly it is an object of the present invention to provide an apparatus for collecting objects, which is a further improvement of the apparatuses of this type.

In keeping with these objects and with others which will become apparent hereinafter, one feature of the present invention resides, briefly stated, in an apparatus for collecting objects, which has a container for receiving and collecting objects; means in said container for determining a weight of the objects introduced into said container; and means providing compensation to a person who introduced an object into said container, based on the weight of the object determined by said weight determining means.

When the apparatus is designed in accordance with the present invention, it provides a stimulus to people to bring the objects and to introduce them into the container, because they obtain certain compensation for this.

In accordance with a further feature of the present invention, the container can be subdivided into a receiving chamber which directly receives an object and in which its weight determination is provided, and a storing chamber, into which the object is introduced after its weight determination in the receiving chamber, and the chambers are periodically separated from one another and thereafter communicated with one another.

In accordance with a further feature of the present invention the apparatus is provided with means for identification of the objects, to determine whether an object introduced into the container is an object desired to be collected in the apparatus.

In a further embodiment of the invention, the compensation providing means is configured so that if the identification means determine that the object is not desirable for the collection in the apparatus, the compensation means do not provide a compensation to a person who introduced such undesirable object into the container.

In still a further embodiment of the invention, the container is provided with means for expelling an object from the container, if the identification means determine that the object introduced into the container is the undesirable object.

The means for providing compensation can be formed as means which dispense a compensation from the apparatus, or means for wirelessly communicating compensation information, or both.

The novel features of the present invention are set forth in particular in the appended claims. The invention itself however, both as to its construction and its manner of operation, will be best understood from the following description of the preferred embodiments, which is accompanied by the following drawings.

### BRIEF DESCRIPTION OF THE DRAWINGS

FIGURE ! is a view schematically showing an apparatus for collecting objects in accordance with the present invention; and

FIG. 2 is a view showing a schematic diagram of components of the inventive apparatus for collecting objects, in their interaction and interjunction.

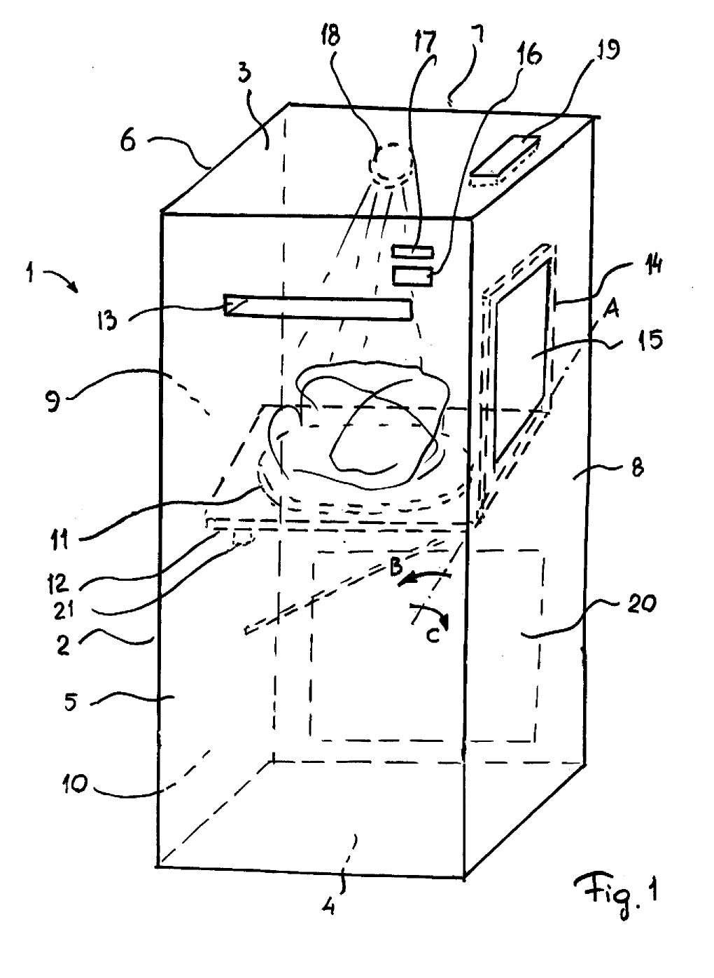

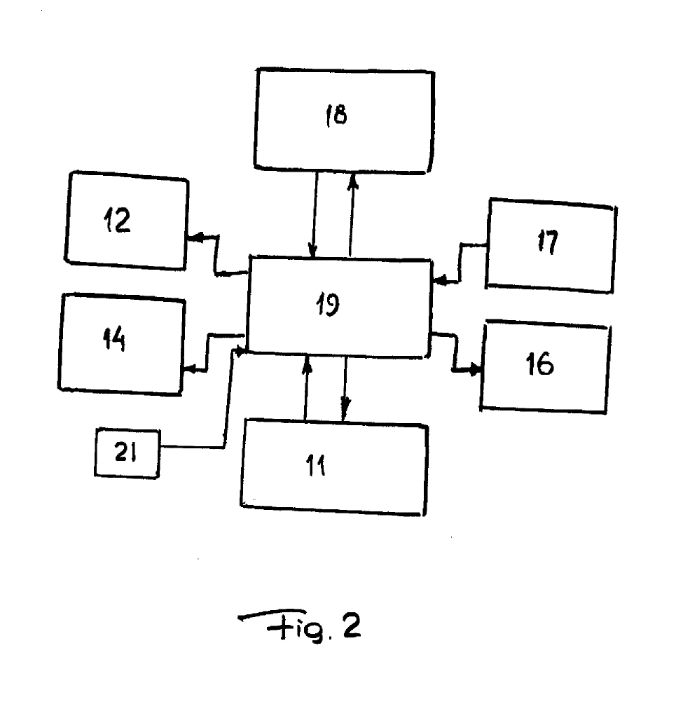

### DESCRIPTION OF THE PREFERRED EMBODIMENTS

An apparatus for collecting objects in accordance with the present invention is identified as a whole with reference numeral 1. The apparatus has a hollow container 2 having a top 3, a bottom 4, and side walls 5, 6, 7, 8 which delimit an inner space of the container.

The container 2 can be subdivided into a receiving chamber 9 and a storing chamber 10. Objects to be collected in the apparatus 1 are first introduced into the receiving chamber 9 which is provided with a weight determining means 11 for determination of a weight of an object introduced into the receiving chamber. The weight determining means can be configured as any known weighing means, such as for example a weighting platform, a weighing scale, an electronic weighing unit, etc.

A partition 12 is provided between the receiving chamber 9 and the storing chamber 10. When an object is first introduced into the receiving chamber 9 through an inlet 13, the partition separates the receiving chamber 9 from the storing chamber 10. Later on, as will be explained hereinbelow, the partition 12 is displaced to communicate the chambers 9 and 10 with one another, so that the object can be introduced into the storing chamber 10 to be stored in the latter.

A flap 14 is provided to close and to open an outlet 15, as will be explained hereinbelow. In one of embodiments, the flap 1 can be connected with the partition 12 to extend substantially vertically and move together with the partition between a closed position and an open position.

The apparatus for collecting objects 1 further has means 16 for providing compensation to a person who introduced an object into the container 10. The compensation providing means 16 can be formed as means which directly dispense a compensation, such as money, coupons, gift cards, statements, etc., or as means for wirelessly transmitting information about the compensation to an authority or to a person who introduced the object into the container, for example to person's e mail, to person's bank account, etc. Both versions and other versions of the operation of the compensation means are possible as well. A user-operated selection unit, for example a keyboard, a set of buttons, etc. 17 can be used by a person to select the manner of compensation which is preferable for him or for her.

The apparatus is further provided with means for identification of objects 18, which determine whether on object introduced by a person is desired to be collected or not. For example is the apparatus is provided to collect clothes, all other objects which are not articles of clothes are undesirable. The identification means 18 can be based on different operational principles, for example electromagnetic testing of the objects by applying electromagnetic radiation to the objects and evaluating the results, image recognition of the objects by obtaining images of the objects and analyzing them, etc. The identification means 18 are operationally connected with the compensation providing means 16 and can be operationally connected with the partition 12 and the flap 15.

The apparatus for collecting objects is further provided with a control unit 19 which can be formed for example as a microprocessor, which controls the operation of the components of the apparatus.

The apparatus for collecting objects in accordance with the present invention operates in the following manner.

When a person introduces an object through the inlet 13 into the receiving chamber 9 of the container 2, the control unit 19 send a signal to the weight determining means and the weight determining means 11 determine the weight of the object. The identification means 18 determine whether the object is a desirable object, and if it is a desirable object the compensation providing means 16 provide compensation to a person. It is also possible that the identification means 18 operate first, and if the object is not a desirable object, the weight determining means do not operate at all to determine the weight of the introduced object.

After the desired object is weighted in the receiving chamber 9, the control unit 19 gives a signal and the partition 12 is turned about an axis A-A counterclockwise in direction of arrow B by not shown means, for example by an electric motor etc., so that it is inclined downwardly as shown in broken lines, and the objects slides from the partition 12 into the storage chamber 10. In this process the flap 14 connected to the partition 12 provides an additional pushing action in the direction of the arrow B.

If however the identification means 18 determine that the object is not a desirable object, the compensation providing means 16 do not provide any compensation to a person who introduced the object into the container. Moreover, the control unit give another signal and the partition 12 with the flap 14 turn clockwise in direction of arrow C, which can be done by the same not shown means, for example the same electric motor. The flap 14 opens the outlet 15 and the not desirable object is expelled from the container, being pushed by the partition 12 in the direction of the arrow C.

It is of course to be understood that the partition 12 and the flap 14 can be separate elements, which are displaceable or pivotable separately and by separate driving means, for example separate electric motors, to perform the above specified inventive functions of separating and communicating the chambers, and for, closing and opening of the outlet.

The apparatus is also provided with a closeable outlet 20 for withdrawal of the collected objects periodically, for example upon their certain accumulation.

In the apparatus in accordance with the present invention also a filling sensor 21 can be provided, which operates so that when the lower chamber of the container 2 is filled to a certain level, the sensor identifies this moment and produces a signal. This signal can be sent to an administrator of the apparatuses to take out the collected objects from the corresponding apparatus. This signal can be also exhibited on the outer wall of the apparatus, for example as a light indicative of the fullness of the container.

The present invention is not limited to the details shown since various modifications and structural changes are possible without departing from the spirit of the invention.

What is desired to be protected by Letters Patent is set forth in particular in the appended claims:

1. An apparatus for collecting objects, comprising a container for receiving and collecting objects; means in said container for determining a weight of an object introduced in said container; and means providing compensation to a person who introduced the object into said container, based on the weight of the object determined by said weight determining means.

2. An apparatus as defined in claim 1, wherein said container is subdivided into a receiving chamber which first receives the object and in which said weight determining means determine the weight of the object, and a storing chamber, into which the object is introduced after the determination of its weight, further comprising means for separating said chambers from one another during the determination of the weight of the object, and then communicating said chambers with one another to allow moving the object from said receiving chamber into said storing chamber.

3. An apparatus as defined in claim 1, further comprising means for identification of the objects introduced into said container, to determine whether the introduced object is desirable for collection or not.

4. An apparatus as defined in claim 3, wherein said compensation providing means is configured to provide compensation to a person who introduced the object into said container only if said identification means determine that the introduced object is desirable for collection.

5. An apparatus as defined in claim 3, wherein said weight determining means is configured to determine the weight of the object introduced into said container only if said identification means determine that the introduced object is desirable for collection.

6. An apparatus as defined in claim 3, further comprising means for expelling from said container the object which is introduced into the container if the identification means determine that the object is not desirable for collection.

7. An apparatus as defined in claim 1, wherein said means for separating and communicating said chambers with each other include a partition pivotable between a separating position and a communicating position, further comprising a flap connected with said partition and pivotable together with the latter, so that when said partition is pivoted from said separating position to said communicating position in one direction said flap assists in pushing the object from said receiving chamber into said storing chamber, and when said partition is pivoted from said separating position in an opposite direction said flap opens an outlet of said container and said partition assists in pushing the object from said container outwardly.

8. An apparatus as defined in claim 1, wherein said means for separating and communicating said chambers with each other include a partition pivotable between a separating position in which it separates said chambers from one another and a communicating position in which said chambers communicate with each other.

9. An apparatus as defined in claim 4, wherein said expelling means include a flap pivotable between a position in which it closes an outlet and opens an outlet for expelling the object which is not desirable for collection.
